(19) United States
(12) Patent Application Publication
(10) Pub. No.: US 2003/0126317 A1
(43) Pub. Date: Jul. 3, 2003

(54) Peripheral monitoring device and computer system having the same

(75) Inventor: Ming-Chih Chang, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP Electronics Inc.

(21) Appl. No.: 10/104,177

(22) Filed: Mar. 22, 2002

(30) Foreign Application Priority Data
Dec. 31, 2001 (TW) 90133411

(51) Int. Cl. G06F 3/00

(52) U.S. Cl. 710/15

(57) ABSTRACT

A peripheral monitoring device and a computer system having the peripheral monitoring device. The peripheral monitoring device has a filtering device and a CPU, in which the filtering device is connected to the peripheral device via a peripheral interface of the computer system to selectively filter peripheral data transmitted via the peripheral interface, and the CPU is connected to the filtering device to control the filtering device to selectively transceive the data transmitted via the peripheral interface.

### BACKGROUND OF THE INVENTION

1. Field of the Invention

The present invention relates to a peripheral monitoring device and a computer system with the peripheral monitoring device, and particularly to a computer system with a peripheral monitoring device embedded on the motherboard of the computer.

2. Description of the Related Art

Generally, a peripheral device is applied to a computer system for data input or output (I/O). Since computer technology nowadays has improved rapidly, various kinds of peripheral device are involved in different APPLICATIONS for performing data I/O. In a computer system, it is common to apply at least one peripheral device for data input, such as a keyboard, a mouse, a video camera or a microphone; and at least one peripheral device for data output, such as a display or a printer.

In either type of data I/O peripheral devices, data transmission exists between the computer system and the peripheral device. Consequently, a peripheral monitoring process ON the data transmission between the computer system and the peripheral device is required considering security demand in operation of the computer system. Conventionally, a peripheral monitoring software package, e.g. Spector or WinGuardian, is applied to perform the required peripheral monitoring process. The conventional peripheral monitoring software is installed directly in the computer system to monitor the peripheral data transmission.

However, there are significant drawbacks in the conventional peripheral monitoring software. If a user decides to install a conventional peripheral monitoring software in the computer system, the peripheral monitoring software must be compatible with the operating system for successful installation. Even if the peripheral monitoring software is successfully installed, it must be stored in storage such as a hard disk and requires execution for regular operation, therefore cannot monitor the data transmission before the execution and might be accidentally or intentionally suspended or interrupted in the peripheral monitoring process. Further, the peripheral monitoring software in operation consumes system resources, which may lead to reduced efficiency or inadequate performance.

On the other hand, a user may apply a conventional hardware-type monitoring device to the computer system only for monitoring data transmission via network; however, data transmission via network does not include all types of data I/O. As a result, the conventional hardware-type monitoring device does not fit to perform the above-mentioned peripheral monitoring process

Further, a monitor system provided near the computer system with the peripheral device is also applicable to externally monitor actions of the peripheral device. For example, a supervisor may install a video camera to monitor the printer of the computer system, so that content printed by the printer is monitored. However, the monitor system which is specialized to monitor the peripheral device increases additional facility cost and may cause monitor dead space due to improper installation. Further, the user of the computer may intentionally move the peripheral device to a different position to easily circumvent the monitor system. Moreover, because the monitor is independent of the computer system, it cannot perform real-time reaction.

### SUMMARY OF THE INVENTION

In view of this, an object of the present invention is to disclose a peripheral monitoring device, and a computer system on whose motherboard the peripheral monitoring device is independently embedded, so that the peripheral monitoring process is independent from the computer system and is not allowed to be interrupted or avoided.

The present invention discloses a peripheral monitoring device, which has a filtering device and a CPU, for a computer system with a peripheral device. The filtering device is connected to a peripheral interface of the computer system to selectively filter data transmitted via the peripheral interface, and the CPU is connected to the filtering device to control the filtering device to selectively transceive the data transmitted via the peripheral interface.

Further, the present invention discloses a computer system with a peripheral device connected thereto. The computer system has a first CPU, a peripheral interface, and a peripheral monitoring device. The peripheral interface connects the first CPU and the peripheral device to perform transmission of data between the first CPU and the peripheral device. The peripheral monitoring device has a filtering device connected to the peripheral interface of the computer system to selectively filter the data transmitted via the peripheral interface, and a second CPU connected to the filtering device to control the filtering device to selectively transceive the data transmitted via the peripheral interface.

Further, the peripheral monitoring device of the present invention is preferably provided with storage to store the data transmitted via the peripheral interface, or the data received and sent by the second CPU. The storage can be random-access memory (RAM), flash memory or a hard disk. The peripheral monitoring device may also have a video camera to video-capture surroundings, and a microphone to sound-capture surroundings.

Further, the peripheral device of the computer system may be an input device such as a keyboard, a mouse, a video camera or a microphone, or an output device such as a display or a printer.

Further, it is preferable that the peripheral monitoring device can be remotely controlled by a remote computer via network.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic diagram showing an embodiment of the computer system having a peripheral monitoring device of the present invention.

### DETAILED DESCRIPTION OF THE PREFERRED EMBODIMENT

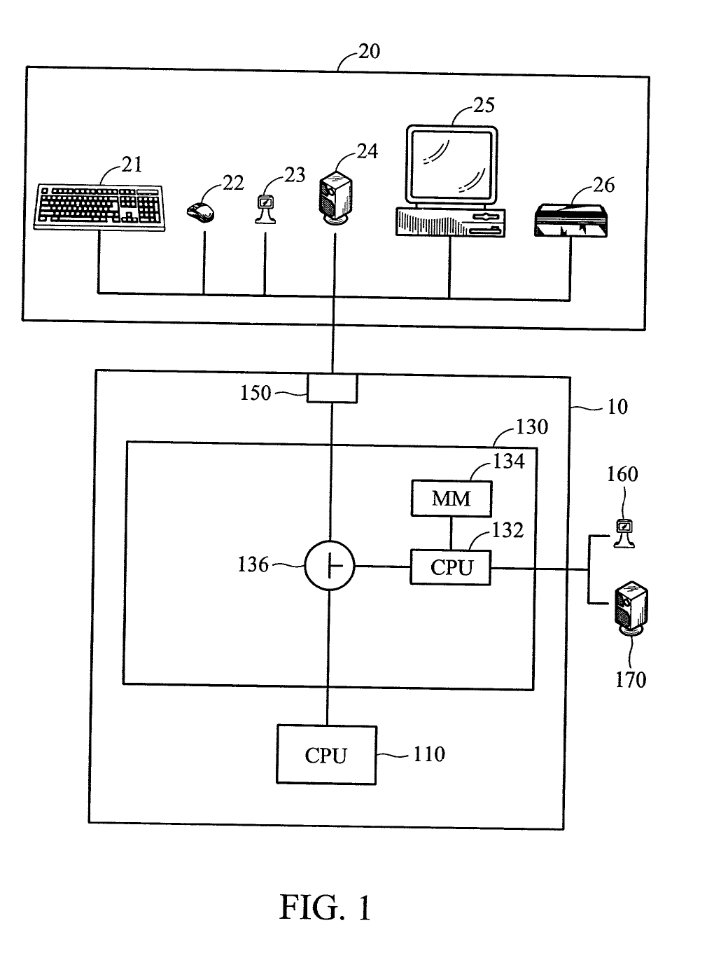

An embodiment of the computer system having the peripheral monitoring device of the present invention is described hereinafter in detail with reference to FIG. 1.

The computer system 10 of the present invention has a first CPU 110 and a peripheral interface 150, as shown in FIG. 1. The first CPU 110 serves as kernel of the computer system 10 and controls operation of the computer system 10. The peripheral interface 150 connects the first CPU 110 and a peripheral device 20, e.g. an input device such as a keyboard 21, a mouse 22, a video camera 23 or a microphone 24, or an output device such as a display 25 or a printer 26. Thus, a user may input data with the keyboard 21 or the mouse 22 to the computer system 10 while receiving data output from the computer system 10 with the display 25 or the printer 26, in which the data is transmitted via the peripheral interface 150.

Meanwhile, the computer system 10 of the present invention is provided with an embedded peripheral monitoring device 130. The peripheral monitoring device 130 has a second CPU 132 and a filtering device 136. The filtering device 136 is connected to the peripheral interface 150 so that the second CPU 132 controls the filtering device 136 to perform filtration. Thus, the peripheral monitoring device 130 receives and filters the data transmitted via the peripheral interface 150. Further, the peripheral monitoring device 130 has a priority to control the data transmission over the computer system 10 by performing the filtration; that is, the peripheral monitoring device 130 is authorized to disable and enable the peripheral interface 150 in case any data transmission with the peripheral device 20 might cause security problem, such as an unauthorized trial to access data in the computer system 10.

In the embodiment of the present invention, the peripheral monitoring device 130 has storage 134, such as a RAM (denoted as MM in FIG. 1), flash memory, a hard disk, or any other type of storage device. The storage 134 stores the data received and sent by the second CPU 132, e.g. the click frequency of the mouse.

Further, the peripheral monitoring device 130 in this embodiment is provided externally with a video camera 160 and a microphone 170. In this case, the peripheral monitoring process is further enhanced to record the images and the sounds of surroundings.

Further, a remote computer may remotely control the peripheral monitoring device 130 of the present invention via network. In this case, the remote computer directly controls the peripheral monitoring device 130 without any system resource consumption, and the user of the computer system 10 is not easily aware of the monitoring process. In this way, a supervisor can remotely monitor peripheral actions in the computer system 10 in real time. If real-time monitoring is not necessary, the supervisor may check the data stored in the storage 134 after.

It should be noted that the peripheral monitoring device 130 in this embodiment is embedded on the motherboard of the computer system 10, so that no external hardware device is required for monitoring. Thus, since it is not easy for the user of the computer system to accidentally interrupt or intentionally remove the embedded device to avoid monitoring, reliability of the peripheral monitoring device 130 is ensured.

Further, the second CPU 132 of the peripheral monitoring device 130 is independent from the first CPU 110 of the computer system 10, so that the monitoring operation does not consume system resource of the computer system 10 and is not in need of compatibility to the OS used in the computer system.

Further, the peripheral monitoring device 130 serves as a subsystem of the computer system 10, so an independent power supply is preferably applied for uninterruptible peripheral monitoring. In this case, the peripheral monitoring device 130 continues monitoring even if the computer system 10 is shutdown, halted or in a standby mode, and the supervisor may access the data stored in the storage 134 regardless of status of the computer system 10.

Specifically, the computer system 10 is preferably accessible via the peripheral monitoring device 130, so that the supervisor may remotely access the computer system 10 in order to ensure further peripheral security control. For example, the peripheral monitoring device 130 provided with a power supply controller of the computer system 10 or a BIOS controller enables the supervisor to remotely access and restore the computer system 10 in case the computer system is intruded or disabled.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A peripheral monitoring device for a computer system with a peripheral device, comprising:
a filtering device connected to a peripheral interface of the computer system to selectively filter data transmitted via the peripheral interface; and
a CPU connected to the filtering device to control the filtering device to selectively transceive the data transmitted via the peripheral interface.

2. The peripheral monitoring device according to claim 1, further comprising:
a video camera to video-capture surroundings; and
a microphone to sound-capture surroundings.

3. The peripheral monitoring device according to claim 1, wherein the peripheral device is an input device.

4. The peripheral monitoring device according to claim 3, wherein the input device is a keyboard, a mouse, a video camera or a microphone.

5. The peripheral monitoring device according to claim 1, wherein the peripheral device is an output device.

6. The peripheral monitoring device according to claim 5, wherein the output device is a display or a printer.

7. The peripheral monitoring device according to claim 1, further comprising storage to store the data transmitted via the peripheral interface.

8. The peripheral monitoring device according to claim 7, wherein the storage is random-access memory (RAM).

9. The peripheral monitoring device according to claim 7, wherein the storage is flash memory.

10. The peripheral monitoring device according to claim 7, wherein the storage is a hard disk.

11. A computer system with a peripheral device connected thereto, comprising:
a first CPU;
a peripheral interface connecting the first CPU and the peripheral device to perform transmission of data between the first CPU and the peripheral device; and
a peripheral monitoring device, comprising:
a filtering device connected to the peripheral interface of the computer system to selectively filter the data transmitted via the peripheral interface; and
a second CPU connected to the filtering device to control the filtering device to selectively transceive the data transmitted via the peripheral interface.

12. The computer system according to claim 11, wherein the peripheral monitoring device further comprises storage to store the data transceived by the second CPU.

13. The computer system according to claim 12, wherein the storage is random-access memory (RAM), flash memory, or a hard disk.

14. The computer system according to claim 11, wherein the peripheral monitoring device further comprises:
a video camera to video-capture surrounding image of the computer system; and
a microphone to sound-capture surrounding sound of the computer system.

15. The computer system according to claim 11, wherein the peripheral device is an input device.

16. The computer system according to claim 15, wherein the input device is a keyboard, a mouse, a video camera or a microphone.

17. The computer system according to claim 11, wherein the peripheral device is an output device.

18. The computer system according to claim 17, wherein the output device is a display or a printer.

20. The computer system according to claim 11, wherein the peripheral monitoring device is remotely controlled by a remote computer via network.
